(19) United States
(12) Patent Application Publication
(10) Pub. No.: US 2014/0358478 A1
(43) Pub. Date: Dec. 4, 2014

(54) MULTIVARIATE YIELD CALCULATOR FOR WAFER INTEGRATED CIRCUIT FABRICATION AND METHOD OF USE THEREOF

(71) Applicant: Nvidia Corporation, Santa Clara, CA (US)

(72) Inventors: Meng Yu, Santa Clara, CA (US); Luai Nassar, Santa Clara, CA (US); Jason Musicer, Santa Clara, CA (US); Himanshu Kumar, Santa Clara, CA (US); Craig Nishizaki, Santa Clara, CA (US); Amit Dave, Santa Clara, CA (US)

(21) Appl. No.: 13/905,972

(22) Filed: May 30, 2013

(51) Int. Cl. G06F 17/18

(52) U.S. Cl. CPC G06F 17/18
USPC 702/181

(57) ABSTRACT

A multivariate yield calculator for wafer integrated circuit (IC) fabrication and a method of generating a multivariate yield forecast using the multivariate yield calculator. One embodiment of the multivariate yield calculator includes: (1) a Gaussian computer configured to compute a mean vector and a covariance matrix from multivariate performance characterizations having a multivariate distribution over a plurality of wafer ICs, and (2) an integrator configured to integrate a probability distribution function (PDF) based on the mean vector and the covariance matrix over a multivariate performance bin, thereby generating a multivariate yield forecast.

### TECHNICAL FIELD

This application is directed, in general, to wafer acceptance tests (WATs) and, more specifically, to multivariate WATs that may be used to forecast yield.

### BACKGROUND

Wafer fabrication is the process by which integrated circuits (ICs) are manufactured. It is basically a process by which a silicon wafer substrate is repeatedly coated, etched and rinsed to form ICs. The wafer is then cut to separate the ICs, which may then be molded into packages for mounting on circuit boards or the like.

Wafer fabrication is a multivariate process and subject to manufacturing defects, however slight they may be. A highly competitive wafer fabrication industry pays a great deal of attention to the occurrence and impact of these defects, the most extreme of which can lead to a wafer batch being scrapped entirely. Accordingly, the industry has developed a multitude of WATs that narrowly identify sub-optimal wafer fabrication. Initially, WATs were used to allow manufacturers to determine whether or not to accept a lot of completed wafers into inventory as sellable products. Over time, WATs began to be used to allow manufacturers to direct their wafer manufacturing and inventory more precisely.

The wafer fabrication industry is largely demand-driven. Consequently, wafer fabrication tends to be carried out with specific end products in mind. As such, a premium is placed on an understanding of precisely how a certain batch or lot of wafers will perform.

Traditional wafer fabrication yield is determined by evaluating finished wafers and allocating each to a performance bin that characterizes the products or applications wafers in that bin are valid and qualified to serve. The evaluations are known as wafer acceptance tests or WATs. Performance bins are generally formed to fit a specific product and are often defined with upper and lower bounds on a physical, often electrical, characteristic. For example, signal processing applications require good noise resistance. Another example is mobile devices, which require substantially low-power ICs. Production of many wafer batches over time lends statistical data for wafer manufacturers to predict yield of future batches.

Alternatively, wafer manufacturers may rely on WATs as the basis for forecasting the ultimate yield of a batch. At some point during the manufacturing process, wafers are subjected to several WATs carried out by automatic test equipment (ATE). ATE is a general category of testing equipment and can be a variety of devices, ranging from simple digital multi-meters to spectrum analyzers and possibly even complex testing software, or any combination of those. The primary product of the ATE is data, and more relevantly, performance data. The ATE data can be analyzed and statistical models formed to make more informed yield forecasts before the final wafers roll off the manufacturing line.

### SUMMARY

One aspect provides a multivariate yield calculator including: (1) a Gaussian computer configured to compute a mean vector and a covariance matrix from multivariate performance characterizations having a multivariate distribution over a plurality of wafer ICs, and (2) an integrator configured to integrate a probability distribution function (PDF) based on the mean vector and the covariance matrix over a multivariate performance bin, thereby generating a multivariate yield forecast.

Another aspect provides a method of multivariate yield forecasting for wafer IC fabrication, including: (1) measuring a plurality of performance characteristics of each of a plurality of wafer ICs in a wafer IC batch, (2) calculating a mean vector and a covariance matrix for the plurality of wafer ICs from the plurality of performance characteristics, (3) employing the mean vector and the covariance matrix in forming a PDF, and (4) integrating the PDF over a multivariate performance bin, thereby generating a multivariate yield forecast for the wafer IC batch.

Yet another aspect provides a WAT system for generating a multivariate yield forecast based on multivariate performance characterizations of a wafer IC batch, including: (1) a plurality of WAT subsystems operable to generate the multivariate performance characterizations, and (2) a yield calculator configured to: (2a) compute a mean vector and covariance matrix from the multivariate performance characterizations, and (2b) compute the multivariate yield forecast based on a probability density function (PDF) that employs the mean vector and covariance matrix.

### BRIEF DESCRIPTION

Reference is now made to the following descriptions taken in conjunction with the accompanying drawings, in which:

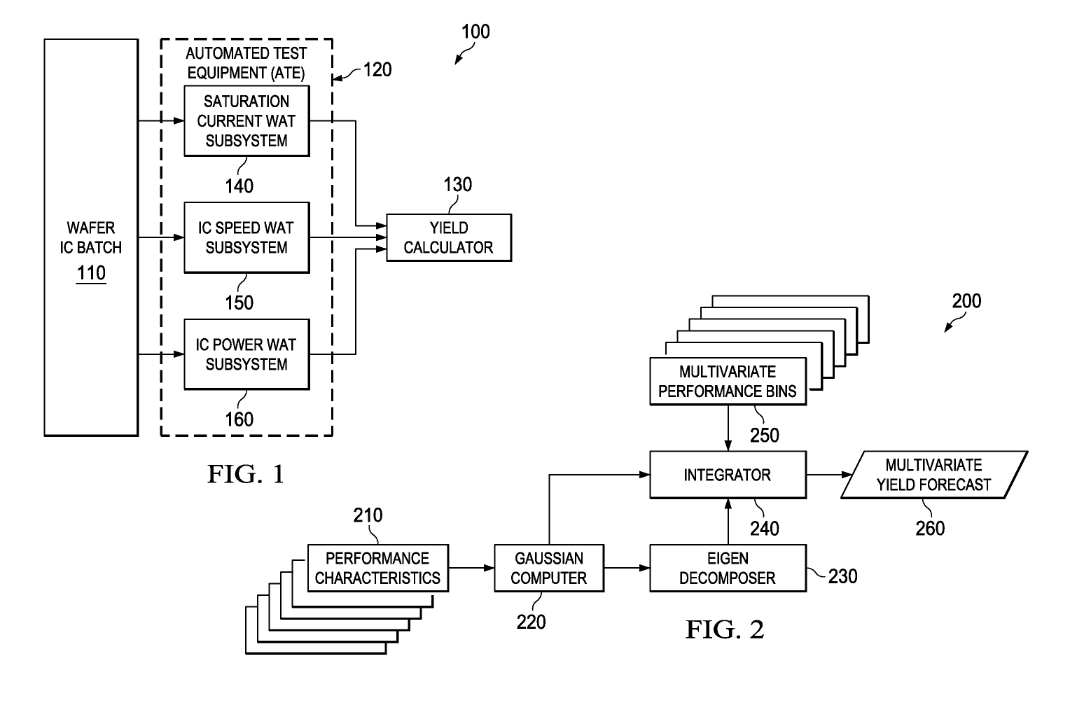

FIG. 1 is a block diagram of one embodiment of a WAT system;

FIG. 2 is a block diagram of one embodiment of a yield calculator; and

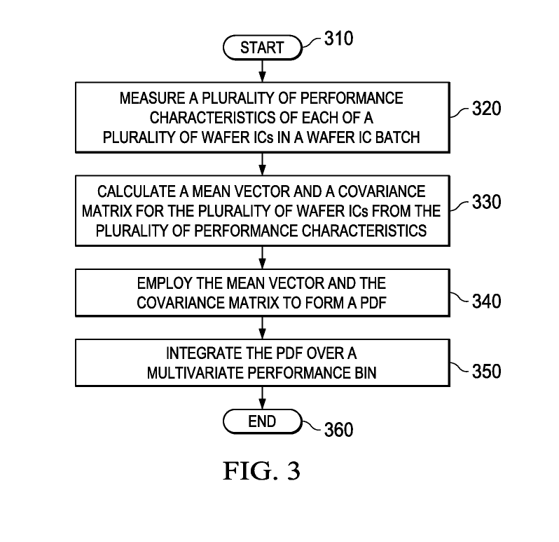

FIG. 3 is a flow diagram of one embodiment of a method for generating a multivariate yield forecast.

### DETAILED DESCRIPTION

Typical wafer fabrication processes operate with many performance targets, ranging from basic mechanical and environmental operating ranges to complex electrical characteristics. However, yield is generally forecasted with respect to one or two parameters, or “performance characteristics.” WATs are used to measure a variety of performance characteristics, generating large amounts of empirical data about a particular batch of wafer ICs. The empirical data for a single performance characteristic is typically compared with that of another performance characteristic to arrive at some correlation between the two parameters. Many wafer fabrication processes leverage this correlation to estimate yield with respect to one or two parameters as a function of one. For example, a fabrication process could predict yield with respect to wafer IC power as a function of measured wafer IC speed.

Measured performance characteristics are generally normally distributed over a batch of wafer ICs. This distribution is sometimes referred to as having a “bell curve.” As such, any one performance characteristic would have a mean value and a standard deviation. From these, a probability density function (PDF) can be defined that represents a probabilistic yield. Given a performance bin for that performance characteristic, the PDF can be integrated over that bin and a fractional yield estimate produced. The fractional yield estimate is essentially the percentage of a batch of wafer ICs that should fall within the performance bin.

In the case of a two-dimensional, or bivariate yield forecast, the probability distribution becomes a bivariate distribution, which is further assumed to be a bivariate normal distribution. The forecast would then be for a bivariate performance bin. The bivariate distribution can be expressed as a joint probability density function, which can be factored into a marginal distribution describing probabilities for one of the variables with no reference to the other and a conditional probability distribution describing probabilities for the other variable conditional on particular values of the one. The conditional aspect effectively reduces the dimension of the forecast by confining, or simplifying boundary conditions for one of the variables. This reduction applies to two or higher dimensions, or “multivariate distributions,” where the conditional probability distribution for a subset of variables is conditional on particular values for the remaining variables.

It is realized herein that, given the assumption that each performance characteristic is normally distributed over a batch, a multivariate distribution can be represented by a mean vector and a covariance matrix. The mean vector and covariance matrix can each be derived empirically from multivariate WAT data. Multivariate WAT data could include a variety of performance characteristics, including wafer IC power, wafer IC speed, wafer IC saturation currents, temperature. Furthermore, in wafers having multiple test points, a wafer IC may have multiples of each of these performance characteristics. For example, a wafer IC having two processing cores could have a speed parameter for both the first and the second core. The combination of performance characteristics used to define multivariate performance bins generally depends on the target product and application. For whichever combination of performance characteristics compose the dimensions of the multivariate distribution, the mean vector for the batch describes the center point of the multivariate normal distribution,

μ=[E[X₁], E[X₂], E[X₃], . . . , E[Xₙ]].

and the covariance matrix describes the shape of the distribution in each dimension,

Σᵢⱼ=Cov(Xᵢ,Xᵢ)=E[(Xᵢ−μᵢ)(Xⱼ−μⱼ)].

It is further realized herein the PDF can be expressed in terms of the mean vector, μ, and the covariance matrix, Σ,

$$PDF ( X ) = \frac{1}{\sqrt{{( 2 π )}^{rank ( \sum )} \vert \sum \vert}} {e}^{- \frac{1}{2} {( X - μ )}^{T} {\sum }^{- 1} ( X - μ )} .$$

Given the PDF for the multivariate normal distribution, a multivariate yield forecast can be determined by integrating over each of the multivariate performance bins. The forecast is generated based on WAT empirical data for a sample set of wafer ICs from the batch and can be extrapolated to cover the entire batch. The forecast is also applicable to future batches of the wafer IC.

It is often the case that a multivariate yield forecast is desired for a batch of a different wafer IC. A particular batch of wafer ICs may have a shortage of WAT data, or a forecast may be desired before even an initial fabrication, for which there would be no WAT data. It is realized herein that expressing the multivariate normal distribution as a PDF in terms of the mean vector and covariance matrix above, provides flexibility to apply aspects of the forecast to another batch of different wafer ICs that have similar characteristics. For example, to wafer ICs in the same product family or generation. It is further realized herein the covariance matrix is a positive definite symmetric matrix, which means it can be factored into an Eigen vector matrix, Q, and an Eigen value matrix, Λ, such that Σ=QΛQ^{T}. In this representation, the Eigen vectors define the direction of the axes of the multivariate distribution, and the Eigen values define the square of the principal axes.

It is realized herein a multivariate yield forecast for the similar batch can be calculated by using covariance replacement and reconstruction. In covariance replacement, the Eigen value matrix for the original batch replaces the Eigen values for the similar batch. The reconstructed covariance matrix can then be used during integration of the PDF.

Before describing various embodiments of the multivariate yield calculator and method of use introduced herein, a WAT system within which various aspects of the invention may be embodied or carried out will be described.

FIG. 1 is a block diagram of one embodiment of a WAT system 100 within which the multivariate yield calculator or method for generating multivariate yield forecasts may be embodied or carried out. WAT system 100 includes automated test equipment (ATE) 120 that carry out a variety of WATs on a sample set of a wafer IC batch 110. The resulting WAT data, which represents a plurality of wafer IC performance characterizations, is fed into a yield calculator 130. Yield calculator 130 generates a yield forecast based on the desired parameters for a given target product or product family.

ATE 120 includes a saturation current WAT subsystem 140, an IC speed WAT subsystem 150 and an IC power WAT subsystem 160. Each of those subsystems provides data to yield calculator 130. In certain embodiments, a particular WAT subsystem may measure the same performance characteristic for multiple portions of a wafer IC. For example, IC power WAT subsystem 160 could make multiple power measurements on a multiple processing core IC. Alternatively, ATE 120 may include a variety of other subsystems, including a temperature WAT subsystem, sheet resistance WAT subsystem and contact resistance WAT subsystem, among many others. In alternate embodiments, ATE 120 may contain a variety of other subsystems, including: a logic analyzer subsystem, a spectrum analyzer subsystem, an electromagnetic field (EMF) WAT subsystem and many others.

The yield forecast may be used simply as an aid to calculating real production yield and inventory. Alternatively, the yield forecast may be used to actively direct ongoing wafer fabrication processes.

Having described a WAT system within which the multivariate yield calculator or method of generating a multivariate yield forecast may be embodied or carried out, several embodiments of the multivariate yield calculator and method of use will be described.

FIG. 2 is a block diagram of one embodiment of a yield calculator 200, such as yield calculator 130 of FIG. 1. Yield calculator 200 includes a Gaussian computer 220, an Eigen decomposer 230 and an integrator 240. Gaussian computer 220 uses the empirical data of performance characteristics 210 to calculate a multivariate normal distribution. The distribution is represented by a PDF expressed in terms of a mean vector and a covariance matrix computed from performance characteristics 210. In certain embodiments, the PDF generated by Gaussian computer 220 is directly integrated by integrator 240. The integration carried out by integrator 240 is performed over at least one of multivariate performance bins 250, which defines the bounds of the integration. The result is a multivariate yield forecast 260. If integrator 240 integrates over multiple multivariate performance bins, each of which are target operating ranges for different products, then multivariate yield forecast 260 is a forecast for all of those products.

In certain embodiments, the multivariate normal distribution calculated by Gaussian computer 220 is passed to Eigen decomposer 230 where the covariance matrix is decomposed, or factored into its Eigen vectors and Eigen values. Given the Eigen vectors and Eigen values, the PDF can be reformed for a batch of similar wafer ICs. The Eigen values for the original batch of wafer ICs can be substituted into the covariance matrix of the similar batch. The reconstructed covariance matrix can then be used in the PDF, which is integrated by integrator 240. The product of integrator 240 in this case is a multivariate yield forecast for the batch of similar wafer ICs.

FIG. 3 is a flow diagram of one embodiment of a method for generating a multivariate yield forecast for wafer IC fabrication. The method begins at a start step 310. At a measuring step 320, a plurality of performance characteristics are measured for each of a plurality of wafer ICs in a batch. The batch of wafer ICs is typically very large, while the sample set, or number of wafer ICs that undergo WAT is considerably smaller. A variety of performance characteristics can be measured during WAT, the combination of which typically depends on the target product. Performance characteristics may include parameters such as power, speed and saturation current. In certain embodiments, multiple power measurements or speed measurements are desired for a particular wafer IC. For instance, a wafer IC having multiple processing cores may have multiple speed measurements taken.

Each performance characteristic is assumed to be normally distributed over the sample wafer ICs. Given that assumption, the multivariate yield forecast for the batch is represented by a multivariate normal distribution. At a calculating step 330, a mean vector and a covariance matrix for the multivariate normal distribution are calculated from the plurality of performance characteristics measured in measuring step 320. The mean vector and the covariance matrix are employed in a PDF forming step 340 to form a PDF for the multivariate normal distribution. The PDF formed in PDF forming step 340 is the basis for the multivariate yield forecast. At an integration step 350, the PDF is integrated over at least one multivariate performance bin. A multivariate performance bin is defined by target operating ranges for each of the performance characterizations performed on each wafer IC in the plurality of wafer ICs. The method then ends at an end step 360.

Those skilled in the art to which this application relates will appreciate that other and further additions, deletions, substitutions and modifications may be made to the described embodiments.

What is claimed is:

1. A multivariate yield calculator, comprising:
a Gaussian computer configured to compute a mean vector and a covariance matrix from multivariate performance characterizations having a multivariate distribution over a plurality of wafer integrated circuits (ICs); and
an integrator configured to integrate a probability distribution function (PDF) based on said mean vector and said covariance matrix over a multivariate performance bin, thereby generating a multivariate yield forecast.

2. The multivariate yield calculator recited in claim 1 wherein each dimension of said multivariate performance characterizations is normally distributed over said plurality of wafer ICs.

3. The multivariate yield calculator recited in claim 1 wherein said multivariate performance characterizations includes four types of wafer acceptance test (WAT) performance measurements.

4. The multivariate yield calculator recited in claim 1 wherein said multivariate performance characterizations includes wafer IC power consumption measurements.

5. The multivariate yield calculator recited in claim 1 wherein said multivariate performance characterizations include IC speed, IC saturation current and IC power measurements.

6. The multivariate yield calculator recited in claim 1 further comprising an Eigen decomposer configured to decompose said covariance matrix into an Eigen vector matrix and an Eigen value matrix.

7. The multivariate yield calculator recited in claim 6 wherein said integrator is further configured to integrate another PDF based on another mean vector for another plurality of wafer ICs and a reconstructed covariance matrix formed from said Eigen value matrix and another Eigen vector matrix for said another plurality of wafer ICs.

8. A method of multivariate yield forecasting for wafer integrated circuit (IC) fabrication, comprising:
measuring a plurality of performance characteristics of each of a plurality of wafer ICs in a wafer IC batch;
calculating a mean vector and a covariance matrix for said plurality of wafer ICs from said plurality of performance characteristics;
employing said mean vector and said covariance matrix in forming a probability density function (PDF); and
integrating said PDF over a multivariate performance bin, thereby generating a multivariate yield forecast for said wafer IC batch.

9. The method recited in claim 8 wherein said measuring includes measuring wafer IC speed.

10. The method recited in claim 8 wherein each of said plurality of performance characteristics is normally distributed over said plurality of wafer ICs.

11. The method recited in claim 8 further comprising computing an Eigen vector matrix and an Eigen value matrix from said covariance matrix.

12. The method recited in claim 11 further comprising reconstructing said covariance matrix based on said Eigen vector matrix combined with another Eigen value matrix based on another wafer IC batch.

13. The method recited in claim 12 wherein said another wafer IC batch is of a distinct wafer IC.

14. The method recited in claim 8 wherein said multivariate performance bin is defined by minimum and maximum values for four performance characteristics.

15. A wafer acceptance test (WAT) system for generating a multivariate yield forecast based on multivariate performance characterizations of a wafer integrated circuit (IC) batch, comprising:
a plurality of WAT subsystems operable to generate said multivariate performance characterizations; and
a yield calculator configured to:
compute a mean vector and covariance matrix from said multivariate performance characterizations, and
compute said multivariate yield forecast based on a probability density function (PDF) that employs said mean vector and covariance matrix.

16. The WAT system recited in claim 15 wherein said plurality of WAT subsystems comprises at least three WAT subsystems respectfully operable to measure at least three performance characteristics.

17. The WAT system recited in claim 15 wherein said yield calculator is operable to:
derive Eigen vectors and Eigen values from said mean vector and covariance matrix; and
employ said Eigen values to generate another multivariate yield forecast for another wafer IC batch.

18. The WAT system recited in claim 15 wherein said multivariate performance characterizations are normally distributed over said wafer IC batch.

19. The WAT system recited in claim 15 wherein said yield calculator is operable to integrate said PDF over a multivariate performance bin to generate said multivariate yield forecast.

20. The WAT system recited in claim 19 wherein said multivariate yield forecast includes a forecast for a plurality of multivariate performance bins.
